(19) United States
(12) Patent Application Publication
(10) Pub. No.: US 2004/0164681 A1
(43) Pub. Date: Aug. 26, 2004

(54) Flat discharge lamp

(76) Inventors: Udo Custodis, Munchen (DE); Angela Eberhardt, Augsburg (DE); Michael Ilmer, Gauting (DE); Reinhard Lecheler, Neuburg/Donau (DE); Herman Schweizer, Diedorf (DE); Michael Seibold, Munchen (DE)

Correspondence Address: OSRAM SYLVANIA INC, 100 ENDICOTT STREET, DANVERS, MA, 01923, US

(21) Appl. No.: 10/484,083

(22) PCT Filed: Jun. 21, 2002
(86) PCT No.: PCT/DE02/02270

(30) Foreign Application Priority Data
Jul. 25, 2001 (DE) 10134965.3

(51) Int. Cl. H01J 17/16

(52) U.S. Cl. 313/635

(57) ABSTRACT

The invention relates to a flat discharge lamp (1) comprising a base plate and a front plate which are connected to a vessel containing an ionizable charge. The exterior side of the front plate which is fitted as a visible surface is provided at least partially with a layer (8). The inventive discharge lamp (1) can be used as a lighting tile.

### TECHNICAL FIELD

The invention relates to a flat discharge lamp which functions firstly for illumination and secondly as a tile. In addition, the invention relates to an illuminating device for using such a flat discharge lamp as a tile in an array of tiles.

### PRIOR ART

In order to tile ceilings, floors and walls in rooms, ceramic tiles are normally used. The room lighting has previously been implemented separately from this by means of familiar lighting devices, for example ceiling, wall or floor lights. Accordingly, these lights are mounted on the ceiling or wall tiles. In this case, there is a danger of damaging tiles during the mounting of the lights.

### SUMMARY OF THE INVENTION

The present invention is based on the object of eliminating this disadvantage and providing a lamp which can be integrated in tiling.

This object is achieved by a flat discharge lamp having the features of claim 1. Particularly advantageous embodiments can be found in the claims dependent thereon.

Furthermore, protection is claimed for the use of such a flat discharge lamp as a tile in accordance with claim 7 and also for a lighting device having such a flat discharge lamp and a holder for this discharge lamp according to claim 8.

The invention proposes a flat discharge lamp, comprising a base plate and a front plate which are connected to form a vessel that encloses an ionizable filling. The outer side of the front plate, envisaged as a visible surface, is at least partly provided with a layer.

This layer is modeled on the appearance of the visible surface of a commercially available tile, so that the discharge lamp according to the invention, when switched off, at least does not differ substantially from such a tile. To this extent, in the individual practical case, the layer can be white or comprise one color, for example, or else designed as an ornament. Furthermore, the layer can cover the outer side either only partly or else completely. In the last-named case, however, the layer still necessarily has to be translucent in order that the discharge lamp according to the invention can still function as a lamp as well as a tile. The external shape of the front plate will generally be matched to that of the relevant commercially available tile. For brevity, the flat discharge lamp according to the invention will also be referred to as a tile lamp in the following text.

The technique by which the light of the tile lamp is produced initially plays a rather subordinate role, ovided that, during operation, at least part of the visible surface of the tile lamp lights up, specifically either with a non-directional Lambert distribution or with the aid of suitable optical devices, for example prismatic films, with any other desired emission characteristics. At least if, during operation, the entire visible surface of the “tile” is intended to light up, the intention is the most uniform light production possible. In this connection, dielectrically impeded discharge, also called dielectric barrier discharge, has proven to be particularly suitable. In flat lamps based on this discharge type, at least some of a large number of electrodes are separated from the filling of the discharge vessel by a dielectric. To this end, the electrodes are either arranged on the outer surface of the base plate of the discharge vessel, as disclosed in EP 0 839 436 B1, the wall of the discharge vessel itself functioning as the aforesaid dielectric. Or the electrodes are arranged on the inner surface of the discharge vessel, in particular the base plate, in this case the electrodes additionally being covered by a dielectric layer, as disclosed in WO 98/43277. The electrodes are normally constructed as structures similar to conductor tracks, which are applied to the inner surface by means of screen printing, for example. In a similar way, these strip-like electrodes are printed with the dielectric layer. The mutual spacing of the electrode tracks is typically in the range of a few millimeters. For further details in this regard, reference is made to WO 99/66538.

This lamp type is preferably operated in accordance with the pulsed operating method disclosed in EP 0 733 266 B1, since it has proven to be particularly efficient as compared with the conventional mode of operation of dielectrically impeded discharges with sinusoidal alternating voltage. In any case, the polarity of adjacent electrodes is selected alternatingly. As a result, the discharge in each case burns between adjacent electrodes.

When the tile lamp is used within an array of tiles, the tile lamp is inserted in the middle of the “normal” tiles surrounding it in a mechanical system which is adapted to hold the lamp, in such a way that the tile lamp is integrated into the overall tile design. Of course, a plurality of tile lamps can also be integrated into the array of tiles in this way.

One advantage of the tile lamp according to the invention is that no complicated mounting of the lamp on the tiles is required and, consequently, the risk of damaging tiles is avoided from the start. In addition, it is advantageous that it only appears during operation as a result of its lighting up. When it is switched off, that is to say not emitting light, the tile lamp virtually cannot be distinguished visually from commercially available tiles, assuming that the visible surface of the tile lamp is matched to the decor of the relevant tile. As a result, the tile lamp is introduced harmoniously into the overall appearance of the array of tiles.

### DESCRIPTION OF THE DRAWINGS

In the following text, the invention is to be explained in more detail using an exemplary embodiment. In the drawings:

FIG. 1a shows a tile lamp according to the invention with a decorative tile layer in plan view,

FIG. 1b shows a sectional illustration along the line AB of the tile lamp from FIG. 1a,

FIG. 1c shows a detail enlargement of a subarea C of the illustration from FIG. 1b,

FIG. 2 shows an array of tiles in an internal room with conventional tiles and light-emitting tile lamps according to FIG. 1a.

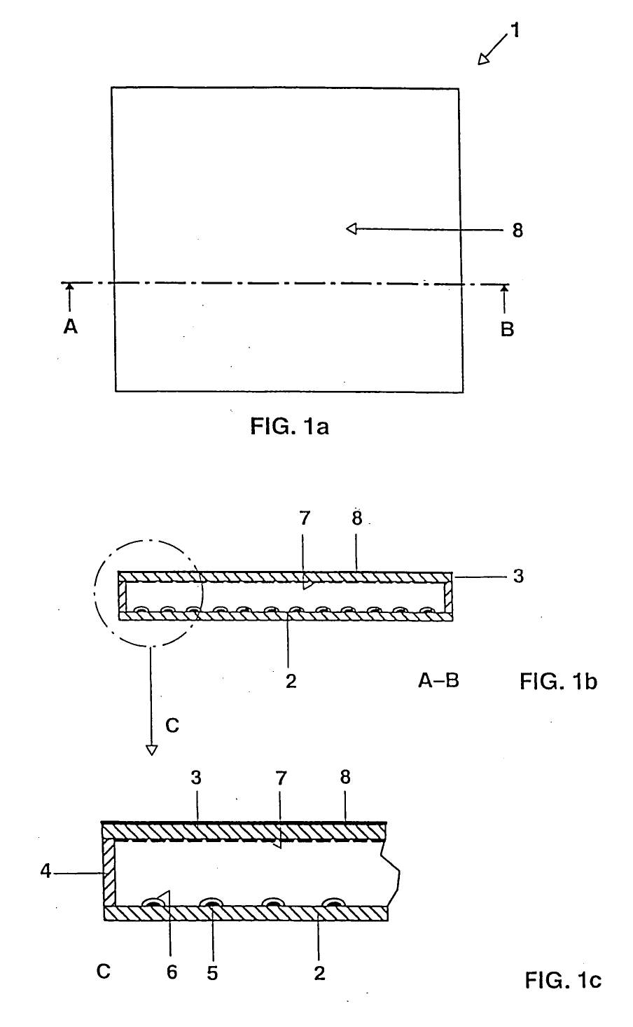

FIGS. 1a to 1c show in schematic form a plan view, a sectional illustration along the line AB and a detail enlargement of a subarea C of a flat discharge lamp (tile lamp) 1 according to the invention, comprising a rectangular base plate 2, a similarly rectangular front plate 3 and a frame 4. The aforementioned components 2 to 4 all consist of glass.

The frame 4 running around in the region of the edges of base plate 2 and front plate 3 connects these two plates 2, 3 to form a flat vessel. The vessel is filled with xenon with a cold filling pressure of about 10 kPa. Strip-like electrodes 5 of silver solder are printed on the inner surface of the base plate 2 and are covered by a glass solder layer 6 acting as a dielectric barrier. Applied to the inner surface of the front plate 2 is a layer 7 of fluorescent material. The layer 12 of fluorescent material consists of a three-band fluorescent material mixture, with which white light can be produced. In the process, the layer 12 of fluorescent material converts the ultraviolet radiation (UV) produced during operation by the discharge within the vessel into visible light. Here, the UV radiation is molecular-band radiation with a maximum at about 172 nm, which is emitted by Xe₂* excimers formed in the discharge. A transparent white decorative layer 8 is applied to the outer surface of the front plate 2, used as a visible surface.

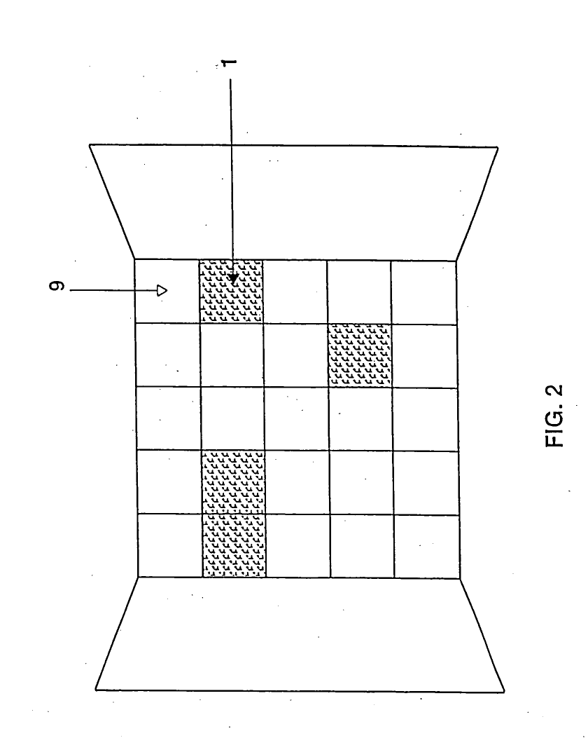

FIG. 2 shows in schematic form a wall of an internal room provided with white sanitary tiles 9, some tiles within the array of tiles having been replaced by light-emitting tile lamps 1 from FIGS. 1a-c. When switched off, that is to say not emitting light, the tile lamps 1 virtually cannot be distinguished visually from the commercially available white sanitary tiles, on account of the transparent white decorative layer 8.

1. A flat discharge lamp (1), comprising a base plate (2) and a front plate (3) which are connected to form a vessel that encloses an ionizable filling, characterized in that the outer side of the front plate (3) is at least partly provided with a layer (8).

2. The discharge lamp as claimed in claim 1, the layer (8) being translucent.

3. The discharge lamp as claimed in claim 1 or 2, the inner side of the front plate (3) being at least partly provided with a layer (7) of fluorescent material.

4. The discharge lamp as claimed in one of the preceding claims comprising electrodes (5) which are arranged on the wall of the vessel in the form of structures similar to conductor tracks.

5. The discharge lamp as claimed in claim 4, at least some of the electrodes (5) being separated from the ionizable filling by a dielectric (6).

6. The discharge lamp as claimed in one of the preceding claims, the two plates (2, 3) being connected by a frame (4) arranged between the two plates (2, 3) and running around along the edge regions of both plates (2, 3).

7. The discharge lamp as claimed in one of the preceding claims as a tile.

8. A lighting device comprising a discharge lamp as claimed in one of the preceding claims 1 to 6 and a holder for this discharge lamp, the lamp holder being designed such that it is suitable for mounting on a flat surface, in particular a ceiling, wall or floor of a room, in an array of tiles.
